(19) United States
(12) Patent Application Publication
(10) Pub. No.: US 2009/0159848 A1
(43) Pub. Date: Jun. 25, 2009

(54) Fluorescent Substance

(75) Inventors: Kenji Toda, Niigata (JP); Mineo Sato, Niigata (JP); Kazuyoshi Uematsu, Niigata (JP); Akira Komeno, Akita (JP); Kenji Kohiro, Tsukuba (JP); Yoshihiko Tsuchida, Tsukuba (JP)

Correspondence Address: FITCH, EVEN, TABIN & FLANNERY, P. O. BOX 18415, WASHINGTON, DC, 20036, US

(73) Assignee: Sumitomo Chemical Company Limited, Chuo-ku Tokyo (JP)

(21) Appl. No.: 11/992,070

(22) PCT Filed: Sep. 15, 2006
(86) PCT No.: PCT/JP2006/318347

§ 371 Date: May 6, 2008

(30) Foreign Application Priority Data
Sep. 15, 2005 (JP) 2005 268013

(51) Int. Cl. C09K 11/54

(52) U.S. Cl. 252/301.6 R

(57) ABSTRACT

A light-emitting device with improved luminescence characteristics, particularly color-rendering properties, includes a phosphor. The phosphor includes a compound represented by formula aM¹O-bM²₂O₃-cM³O₂, wherein M¹ represents at least one element selected from the group consisting of Ba, Sr, Ca, Mg and Zn, M² represents at least one element selected from the group consisting of Al, Sc, Ga, Y, In, La, Gd and Lu, M³ represents at least one element selected from the group consisting of Si, Ti, Ge, Zr, Sn and Hf, a is a value of not less than 8 and not more than 10, b is a value of not less than 0.8 and not more than 1.2, and c is a value of not less than 5 and not more than 7, and having at least one element as an activator selected from the group consisting of rare earth elements, Mn, Bi and Zn incorporated into the compound.

### TECHNICAL FIELD

The present invention relates to a phosphor.

### BACKGROUND ART

Phosphors are used for light emitting devices such as white LED. The white LED is a white light emitting device comprising a light emitting element and a phosphor which emits light by excitation with at least a part of light emitted by the light emitting element. As the light emitting element used for white LED, mention may be made of a light emitting element which emits blue light (hereinafter sometimes referred to as “blue LED”) and a light emitting element which emits near ultraviolet light to bluish purple light (hereinafter sometimes referred to as “near ultraviolet LED”). As a phosphor which emits light upon excitation with the light emitted by the above light emitting elements, there is known Y₃Al₅O₁₂:Ce (see, for example, Patent Document 1).

Patent Document 1: JP-A-10-242513

### DISCLOSURE OF INVENTION

### Problem to be Solved by the Invention

However, light emitting devices using conventional phosphors cannot be said to be sufficient in luminescence characteristics which are mainly color rendering properties. The object of the present invention is to provide a phosphor which can provide a light emitting device which is practically improved in luminescence characteristics which are mainly color rendering properties. Further object of the present invention is to provide a phosphor which can provide a white LED which is improved in luminescence characteristics which are mainly color rendering properties.

### Means for Solving the Problem

As a result of intensive research conducted by the inventors, the present invention has been accomplished.

That is, the present invention provides the following phosphor and light emitting device.

<1> A phosphor comprising a compound represented by the formula aM¹O.bM²₂O₃.cM³O₂ (wherein M¹ represents at least one element selected from the group consisting of Ba, Sr, Ca, Mg and Zn; M² represents at least one element selected from the group consisting of Al, Sc, Ga, Y, In, La, Gd and Lu; M³ represents at least one element selected from the group consisting of Si, Ti, Ge, Zr, Sn and Hf; a is a value of not less than 8 and not more than 10; b is a value of not less than 0.8 and not more than 1.2; and c is a value of not less than 5 and not more than 7), said compound comprising at least one element selected from the group consisting of rare earth elements, Mn, Bi and Zn as an activator.

<2> The above phosphor, wherein the activator is at least one element selected from the group consisting of Ce, Pr, Nd, Sm, Eu, Tb, Dy, Ho, Er, Tm, Yb, Mn, Bi and Zn.

<3> The above phosphor consisting essentially of a compound represented by the formula (M¹₁₋ₓReₓ)₉M²₂M³₆O₂₄ (wherein M¹ represents at least one element selected from the group consisting of Ba, Sr, Ca, Mg and Zn; M² represents at least one element selected from the group consisting of Al, Sc, Ga, Y, In, La, Gd and Lu; M³ represents at least one element selected from the group consisting of Si, Ti, Ge, Zr, Sn and Hf; Re represents at least one element selected from the group consisting of Sm, Eu, Tm, Yb, Mn and Zn; and x is a value of more than 0 and less than 1).

<4> The above phosphor, wherein x is a value of not less than 0.01 and not more than 0.2.

<5> The above phosphor, wherein M¹ represents at least one element selected from the group consisting of Ba, Sr and Ca.

<6> The above phosphor, wherein M² represents Sc and/or Y.

<7> The above phosphor, wherein M³ represents Si and/or Ge.

<8> A light emitting device comprising the phosphor mentioned above.

<9> A light emitting device comprising a light emitting element and a fluorescent material which emits light by excitation with at least a part of light emitted by the light emitting element, wherein the fluorescent material comprises the phosphor mentioned above.

<10> The above light emitting device,

wherein the light emitted by the light emitting element show maximum emission intensity at a wavelength (λmax) of not shorter than 350 nm and not longer than 480 nm in a wavelength-emission intensity curve of a wavelength range of not shorter than 300 nm and not longer than 780 nm.

### ADVANTAGES OF THE INVENTION

The phosphor of the present invention emits a light by efficient excitation with near ultraviolet light to blue light, namely, a light of wavelength in the range of not shorter than 350 nm and not longer than 480 nm, specifically, a light which shows maximum emission intensity at an wavelength (λmax) of not shorter than 350 nm and not longer than 480 nm in a wavelength-emission intensity curve of a wavelength range of not shorter than 300 nm and not longer than 780 nm. By combining a fluorescent material comprising the phosphor of the present invention with a light emitting element emitting near ultraviolet light to blue light, namely, a blue LED or a near ultraviolet LED, there can be obtained a white LED practically improved in luminescence characteristics which are mainly color rendering properties. Furthermore, in the case of a phosphor of the present invention, the maximum emission intensity is sometimes obtained at about 510 nm in its luminescence spectrum, and when this phosphor is used, it becomes possible to produce a white LED superior in color rendering properties to conventional white LED. Moreover, the phosphor of the present invention is less in decrement of emission intensity at high temperatures of about 100° C. as compared with emission intensity at room temperature, and can be used for light emitting devices based on ultraviolet excitation, such as back light for liquid crystal and fluorescent lighting, light emitting devices based on vacuum ultraviolet excitation, such as plasma display panel and rare gas lamp, light emitting devices based on electron beam excitation, such as Braun tube and FED (Field Emission Display), light emitting devices based on X-ray excitation, such as X-ray imaging device, light emitting devices based on electric field excitation, such as inorganic EL display, etc., and thus the phosphor of the present invention is industrially very useful.

### BEST MODE FOR CARRYING OUT THE INVENTION

The present invention will be explained in detail below.

The phosphor of the present invention comprises a compound represented by the formula (1): aM¹O.bM²₂O₃.cM³O₂ which comprises at least one element selected from the group consisting of rare earth elements, Mn, Bi and Zn as an activator. In the formula (1), M¹ represents at least one element selected from the group consisting of Ba, Sr, Ca, Mg and Zn; M² represents at least one element selected from the group consisting of Al, Sc, Ga, Y, In, La, Gd and Lu; M³ represents at least one element selected from the group consisting of Si, Ti, Ge, Zr, Sn and Hf; a is a value of not less than 8 and not more than 10; b is a value of not less than 0.8 and not more than 1.2; and c is a value of not less than 5 and not more than 7.

From the point of luminescence characteristics, the activator is preferably at least one element selected from the group consisting of Ce, Pr, Nd, Sm, Eu, Tb, Dy, Ho, Er, Tm, Yb, Mn, Bi and Zn. The activator is more preferably at least one element selected from the group consisting of Sm, Eu, Tm, Yb, Mn, Bi and Zn, further preferably a combination of at least Eu as an essential element and optionally at least one element selected from the group consisting of Sm, Tm, Yb, Mn, Bi and Zn.

Furthermore, in the formula (1), a is preferably 9, b is preferably 1.0, and c is preferably 6. When a, b and c are these values, the emission intensity of the phosphor of the present invention tends to be able to be further enhanced.

Therefore, the phosphor of the present invention substantially comprises a compound represented by the formula (2): (M¹₁₋ₓReₓ)₉M²₂M³₆O₂₄. In the formula (2), M¹ represents at least one element selected from the group consisting of Ba, Sr, Ca, Mg and Zn; M² represents at least one element selected from the group consisting of Al, Sc, Ga, Y, In, La, Gd and Lu; M³ represents at least one element selected from the group consisting of Si, Ti, Ge, Zr, Sn and Hf; Re represents at least one element selected from the group consisting of Sm, Eu, Tm, Yb, Mn and Zn; x is a value of more than 0 and less than 1. Here, from the point of luminescence characteristics, Re is preferably a combination of at least Eu as an essential element and optionally at least one element selected from the group consisting of Sm, Tm, Yb, Mn and Zn.

In the formula (2), x is preferably a value in the range of not less than 0.001 and not more than 0.5, more preferably a value in the range of not less than 0.01 and not more than 0.3, further preferably a value in the range of not less than 0.01 and not more than 0.2. When the value of x is in the above range, the emission intensity of the phosphor of the present invention tends to be further enhanced or the wavelength of light which excites the phosphor tends to be changed in the range of near ultraviolet light to blue light.

M¹ in the formula (1) and formula (2) is preferably at least one element selected from the group consisting of Ba, Sr and Ca, more preferably Ba and/or Sr, further preferably Ba and Sr. When M¹ is the above element(s), the emission intensity of the phosphor of the present invention tends to be further enhanced.

M² in the formula (1) and formula (2) is preferably Sc and/or Y, more preferably Sc. When M² is the above element(s), the emission intensity of the phosphor of the present invention tends to be further enhanced.

M³ in the formula (1) and formula (2) is preferably Si and/or Ge, more preferably Si. When M³ is the above element(s), the emission intensity of the phosphor of the present invention tends to be further enhanced.

Moreover, the phosphor of the present invention may comprise at least one element selected from the group consisting of F, Cl, Br and I so long as they do not hinder the attainment of the object of the present invention. The content of these elements is not less than 1 ppm and not more than 10000 ppm, preferably not less than 1 ppm and not more than 1000 ppm based on the total weight of the phosphors comprising these elements. When the phosphor of the present invention comprises at least one element selected from the group consisting of F, Cl, Br and I as above, the emission intensity of the phosphor of the present invention may further be enhanced.

Next, the process for producing the phosphor of the present invention will be explained.

The phosphor of the present invention can be produced, for example, in the following manner. The phosphor of the present invention can be produced by calcining a mixture of metal compounds which become the phosphor of the present invention by calcining. That is, it can be produced by weighing compounds comprising the corresponding metal elements so that a given composition can be obtained, mixing the compounds, and then calcining the resulting mixture of the metal compounds. For example, a phosphor represented by the formula (Ba_{0.95}Eu_{0.05})₉Sc₂Si₆O₂₄ which is one of the preferred compositions can be produced by weighing BaCO₃, Eu₂O₃, Sc₂O₃ and SiO₂ to give a molar ratio of Ba:Eu:Sc:Si of 8.55:0.45:2:6, mixing them and calcining the mixture.

The compounds comprising the above metal elements include those comprising barium, strontium, calcium, magnesium, zinc, aluminum, scandium, gallium, yttrium, indium, lanthanum, gadolinium, lutetium, silicon, titanium, germanium, zirconium, tin, hafnium, cerium, praseodymium, neodymium, samarium, europium, terbium, dysprosium, holmium, erbium, thulium, ytterbium, manganese and bismuth, and there may be used, for example, oxides or those compounds which can become oxides by decomposition and/or oxidation at high temperatures, such as hydroxides, carbonates, nitrates, halides and oxalates.

For mixing the compounds comprising the above metal elements, there may be used apparatuses which are industrially ordinarily used, such as ball mill, twin-cylinder mixer and stirrer. Either of wet mixing and dry mixing can be employed.

The phosphor of the present invention is obtained by calcining the mixture of the metal compounds with keeping the mixture, for example, at a temperature in the range of 700-1600° C. for 1-100 hours. When the mixture of the metal compounds comprises compounds which can become oxides by decomposition and/or oxidation at high temperatures, such as hydroxides, carbonates, nitrates, halides and oxalates, the mixture of the metal compounds can be made to oxides, for example, by pre-calcining it with keeping at a temperature lower than calcining temperature or it may be removed water of crystallization before pre-calcining. Furthermore, the mixture can be ground after pre-calcination.

As the atmospheres for calcining, mention may be made of inert atmospheres such as nitrogen and argon, oxidizing atmospheres such as air, oxygen, oxygen-containing nitrogen and oxygen-containing argon, and reducing atmospheres such as hydrogen-containing nitrogen containing 0.1-10 vol % of hydrogen and hydrogen-containing argon containing 0.1-10 vol % of hydrogen. When calcining is carried out in a strong reducing atmosphere, a suitable amount of carbon may be added to the mixture of metal compounds. Furthermore, in order to heighten the crystallinity of the resulting phosphor, a suitable amount of a reaction accelerator may be present in the mixture of metal compounds at the time of calcining or pre-calcining. When the reaction accelerator is present, the phosphor sometimes shows high emission intensity. Examples of the reaction accelerator are LiF, NaF, KF, LiCl, NaCl, KCl, Li₂CO₃, Na₂CO₃, K₂CO₃, NaHCO₃, NH₄Cl, NH₄I, etc. If necessary, a surface treatment with inorganic material or organic material may be effected for improvement of endurance.

The phosphor obtained by the above processes can be ground using ball mill, jet mill or the like. Moreover, the resulting phosphor can be washed and classified. The calcining can be carried out twice or more times. The method for making light emitting device is not particularly limited, and known method can be employed. For example, the method disclosed in U.S. Pat. No. 6,614,179 is used, and the contents of which are hereby incorporated by reference.

The phosphors obtained as mentioned above can be used for light emitting devices such as white LED, back light for liquid crystal, fluorescent lighting, plasma display panel, rare gas lamp, Braun tube, FED, X-ray imaging device and inorganic EL display, etc. The method for making the light emitting devices is not particularly limited, and known method can be employed. For example, the method disclosed in U.S. Pat. No. 6,614,179 is used, and the contents of which are hereby incorporated by reference.

The phosphor of the present invention can emit light by excitation with near ultraviolet light to blue light, namely, light of wavelength in the range of not shorter than 350 nm and not longer than 480 nm, preferably not shorter than 380 nm and not longer than 460 nm. Therefore, the phosphor is excited with a light which shows maximum emission intensity at a wavelength (λmax) of not shorter than 350 nm and not longer than 480 nm, preferably not shorter than 380 nm and not longer than 460 nm in a wavelength-emission intensity curve of a wavelength range of not shorter than 300 nm and not longer than 780 nm, and thus a light emitting device can be obtained by combining the phosphor with blue LED or near ultraviolet LED. The fluorescent material comprises at least the phosphor of the present invention, and furthermore may comprise other phosphors as mentioned hereinafter. The fluorescent material may be excited with at least a part of the light in the above range.

Next, the light emitting element used in the light emitting device will be specifically explained taking blue LED or near ultraviolet LED as an example. Blue LED or near ultraviolet LED can be produced by known methods as disclosed, for example, in JP-A-6-177423, JP-A-11-191638 and U.S. Pat. No. 6,346,720. The method disclosed in U.S. Pat. No. 6,346,720 is hereby incorporated by reference. That is, the light emitting element has a structure comprising a substrate on which are laminated an n-type compound semiconductor layer (n-type layer), a light emitting layer comprising a compound semiconductor (light emitting layer) and a p-type compound semiconductor layer (p-type layer). The substrate comprises sapphire, SiC, Si or the like. The methods for lamination of the compound semiconductor layers include, for example, generally employed MOVPE (Metal Organic Vapor Phase Epitaxy) method, MBE (Molecular Beam Epitaxy) method, etc. As the basic composition of the compound semiconductor of the light emitting layer, there are used GaN, InᵢGa₁₋ᵢN (0<i<1), InᵢAlⱼGa₁₋ᵢ₋ⱼN (0<i<1, 0<j<1, i+j<1), etc. By changing this composition, wavelength of the emitted light, namely, that of near ultraviolet light to bluish purple light or blue light, can be changed. Furthermore, it is preferred that the amount of the impurity contained in the light emitting layer is small. Specifically, when elements of Si, Ge and Group 2 elements are used as impurities, the concentration thereof is preferably 10¹⁷ cm⁻³ or less. The light emitting layer may be of single quantum well structure or multiple quantum well structure. The thickness of the light emitting layer is preferably not less than 5 Å and not more than 300 Å, more preferably not less than 10 Å and not more than 90 Å. If the thickness is less than 5 Å or more than 300 Å, emission efficiency of the light emitting element is sometimes insufficient.

As the n-type layer and p-type layer, a compound semiconductor having a band gap greater than that of the compound semiconductor of the light emitting layer is used. By providing the light emitting layer between the n-type layer and p-type layer, a light emitting element can be obtained. Furthermore, if necessary, there may be inserted some layers differing in composition, conductivity and doping concentration between the n-type layer and the light emitting layer and between the light emitting layer and the p-type layer. As the basic compositions of the compound semiconductor of the insertion layer, mention may be made of, for example, the above-mentioned InᵢAlⱼGa₁₋ᵢ₋ⱼN (0<i<1, 0<j<1, i+j<1), and among them, those which differ from the light emitting layer in composition, conductivity, doping concentration, etc. are used.

The two layers adjacent to the light emitting layer are called charge injection layers. When the above insertion layers are present, they act as the charge injection layers, and when the insertion layers are not present, the n-type layer and p-type layer act as the charge injection layers. Positive charge and negative charge are injected into the light emitting layer by the two charge injection layers, and these charges per se are recombined to emit light. In order to efficiently recombine the charges injected into the light emitting layer and obtain a light of high intensity, it is preferred that the light emitting element has a structure in which charge injection layers are formed by inserting an insertion layer having a band gap greater than that of the light emitting layer between the n-type layer and the light emitting layer and between the light emitting layer and the p-type layer (said structure being so-called double-hetero structure). The difference in band gap between the charge injection layer and the light emitting layer is preferably 0.1 eV or greater. If the difference in band gap between the charge injection layer and the light emitting layer is smaller than 0.1 eV, confinement of carriers in the light emitting layer is not sufficient, and thus emission efficiency of the light emitting element may lower. The difference in band gap is more preferably 0.3 eV or greater. However, if the band gap of the charge injection layer exceeds 5 eV, voltage necessary for injection of charge increases and hence the band gap of the charge injection layer is preferably 5 eV or smaller. The thickness of the charge injection layer is preferably not less than 5 Å and not more than 5000 Å. If the thickness of the charge injection layer is less than 5 Å or more than 5000 Å, the emission efficiency of the light emitting element tends to deteriorate. The thickness of the charge injection layer is more preferably not less than 10 Å and not more than 2000 Å.

The light emitting element produced as mentioned above emits light which shows maximum emission intensity at a wavelength (λmax) of not shorter than 350 nm and not longer than 480 nm in a wavelength-emission intensity curve of a wavelength range of not shorter than 300 nm and not longer than 780 nm. Here, the wavelength-emission intensity curve is a curve shown by plotting the emission intensity against the wavelength of light, and is sometimes called a luminescence spectrum. The wavelength-emission intensity curve can be obtained using a spectrofluorometer.

Next, the method for producing a white LED as an example of light emitting device comprising the above light emitting element and a fluorescent material which emits light by excitation with at least a part of light emitted by the light emitting element will be explained. The white LED can be produced by using blue LED or near ultraviolet LED as a light emitting element, and, for example, by sealing the light emitting element with a light transmission resin such as an epoxy resin and disposing a fluorescent material to cover the surface of the light emitting element. In this case, composition and amount of the fluorescent material is suitably set so as to emit desired white light. As the fluorescent material, the phosphor of the present invention can be used alone or in combination with other phosphors. For example, in the case of constructing a complementary white LED using a blue LED and yellow phosphor (see FIG. 6 as for the luminescence spectrum of conventional such complementary LED), color rendering can be improved by further adding the phosphor of the present invention having a maximum emission intensity at about 510 nm. Moreover, when a three-wavelength type white LED is constructed by combining a near ultraviolet LED with blue, green and red phosphors, the phosphor of the present invention can be used as a blue phosphor which is satisfactorily excited with near ultraviolet light and is excellent in emission intensity. Examples of the other phosphors are BaMgAl₁₀O₁₇:Eu, (Ba,Sr,Ca) (Al,Ga)₂S₄:Eu, BaMgAl₁₀O₁₇:Eu,Mn, BaAl₁₂O₁₉:Eu,Mn, (Ba,Sr,Ca)S:Eu,Mn, Y₃Al₅O₁₂:Ce, (Y,Gd)₃Al₅O₁₂:Ce, YBO₃:Ce,Tb, Y₂O₃:Eu, Y₂O₂S:Eu, YVO₄:Eu, (Ca,Sr)S:Eu, SrY₂O₄:Eu, Ca—Al—Si—O—N:Eu, Li—(Ca,Mg)-Ln-Al—O—N:Eu (where Ln represents a rare earth metal element other than Eu), and they are not limited to these phosphors, and furthermore, phosphors developed in the future may naturally be used in combination with the phosphor of the present invention.

### EXAMPLE

The present invention will be explained in more detail by the following examples, which should not be construed as limiting the invention.

### Example 1

The starting materials of barium carbonate, europium oxide, scandium oxide, and silicon dioxide were weighed to give a molar ratio of Ba:Eu:Sc:Si of 8.55:0.45:2:6, and were mixed for 4 hours by a wet ball mill using acetone to obtain a slurry. The resulting slurry was dried by an evaporator, then the resulting mixture of metal compounds was kept at a temperature of 1300° C. for 6 hours in the air atmosphere to fire the mixture, and then the mixture was slowly cooled to room temperature. Thereafter, the mixture was ground by an agate mortar and was kept at a temperature of 1300° C. for 6 hours in an Ar atmosphere containing 5 vol % of H₂, thereby to fire the ground mixture, followed by slowly cooled to room temperature to obtain phosphor 1 comprising a compound represented by the formula (Ba_{0.95}Eu_{0.05})₉Sc₂Si₆O₂₄.

The luminescence characteristics of phosphor 1 were evaluated in terms of excitation spectrum and luminescene spectrum obtained using a spectrofluorometer (manufactured by JASCO Corporation). It was found that the phosphor 1 was excited with a light having a wavelength of not shorter than 350 nm and not longer than 480 nm and emitted light having a maximum emission intensity at a wavelength of 510 nm. The results are shown in FIG. 1 and Table 1.

### Example 2

The starting materials of barium carbonate, strontium carbonate, europium oxide, scandium oxide and silicon dioxide were weighed to give a molar ratio of Ba:Sr:Eu:Sc:Si of 8.1:0.45:0.45:2:6, and phosphor 2 comprising a compound represented by the formula (Ba_{0.9}Sr_{0.05}Eu_{0.05})₉Sc₂Si₆O₂₄ was obtained in the same manner as in Example 1.

The luminescence characteristics of the phosphor 2 were evaluated in terms of excitation spectrum and luminescence spectrum obtained using a spectrofluorometer (manufactured by JASCO Corporation).

It was found that the phosphor 2 was excited with a light having a wavelength of not shorter than 350 nm and not longer than 480 nm and emitted light having a maximum emission intensity at a wavelength of 513 nm. The results are shown in FIG. 2 and Table 1.

### Examples 3-7

Using barium carbonate, europium oxide, scandium oxide and silicon dioxide as starting materials, phosphors 3-7 comprising compounds shown in Examples 3-7 in Table 1 were obtained in the same manner as in Example 1. The luminescence characteristics of the phosphors 3-7 were evaluated in terms of excitation spectrum and luminescence spectrum obtained using a spectrofluorometer (manufactured by JASCO Corporation). The results obtained are shown in Table 1. Furthermore, excitation spectra and luminescence spectra in phosphors 3-5 are shown in FIG. 3-FIG. 5.

Luminescence spectrum of a conventional white LED which emits white light by additive color mixture of blue LED and yellow phosphor is shown in FIG. 6. In the luminescence spectrum of the conventional white LED, emission intensity at about 510 nm is low, and color rendering of white LED can be improved by combining the phosphor of the present invention with the conventional white LED.

TABLE 1

| | | | Wavelength | Wavelength | |
|---|---|---|---|---|---|
| | | | of light | at maximum | Maximum emission |
| | | | exciting | emission | intensity |
| Example | Phosphor | Formula of compound | phosphor | intensity | (relative value) |
| Example 1 | Phosphor 1 | (Ba_{0.95}Eu_{0.05})₉Sc₂Si₆O₂₄ | 433 nm | 510 nm | 100 |
| Example 2 | Phosphor 2 | (Ba_{0.9}Sr_{0.05}Eu_{0.05})₉Sc₂Si₆O₂₄ | 428 nm | 513 nm | 109 |
| Example 3 | Phosphor 3 | (Ba_{0.99}Eu_{0.01})₉Sc₂Si₆O₂₄ | 384 nm | 504 nm | 72 |
| Example 4 | Phosphor 4 | (Ba_{0.9}Eu_{0.1})₉Sc₂Si₆O₂₄ | 444 nm | 515 nm | 53 |
| Example 5 | Phosphor 5 | (Ba_{0.85}Eu_{0.15})₉Sc₂Si₆O₂₄ | 447 nm | 518 nm | 30 |
| Example 6 | Phosphor 6 | (Ba_{0.98}Eu_{0.02})₉Sc₂Si₆O₂₄ | 382 nm | 506 nm | 62 |
| Example 7 | Phosphor 7 | (Ba_{0.8}Eu_{0.2})₉Sc₂Si₆O₂₄ | 448 nm | 522 nm | 28 |

### INDUSTRIAL APPLICABILITY

A white LED improved practically in luminescence characteristics which are mainly color rendering properties can be obtained by combining a fluorescent material comprising the phosphor of the present invention with a light emitting element which emits near ultraviolet light to blue light, namely, blue LED or near ultraviolet LED.

### BRIEF DESCRIPTION OF DRAWINGS

FIG. 1 Excitation spectrum and luminescence spectrum of phosphor 1 of Example 1.

FIG. 2 Excitation spectrum and luminescence spectrum of phosphor 2 of Example 2.

FIG. 3 Excitation spectrum and luminescence spectrum of phosphor 3 of Example 3.

FIG. 4 Excitation spectrum and luminescence spectrum of phosphor 4 of Example 4.

FIG. 5 Excitation spectrum and luminescence spectrum of phosphor 5 of Example 5.

FIG. 6 Luminescence spectrum of the conventional white LED.

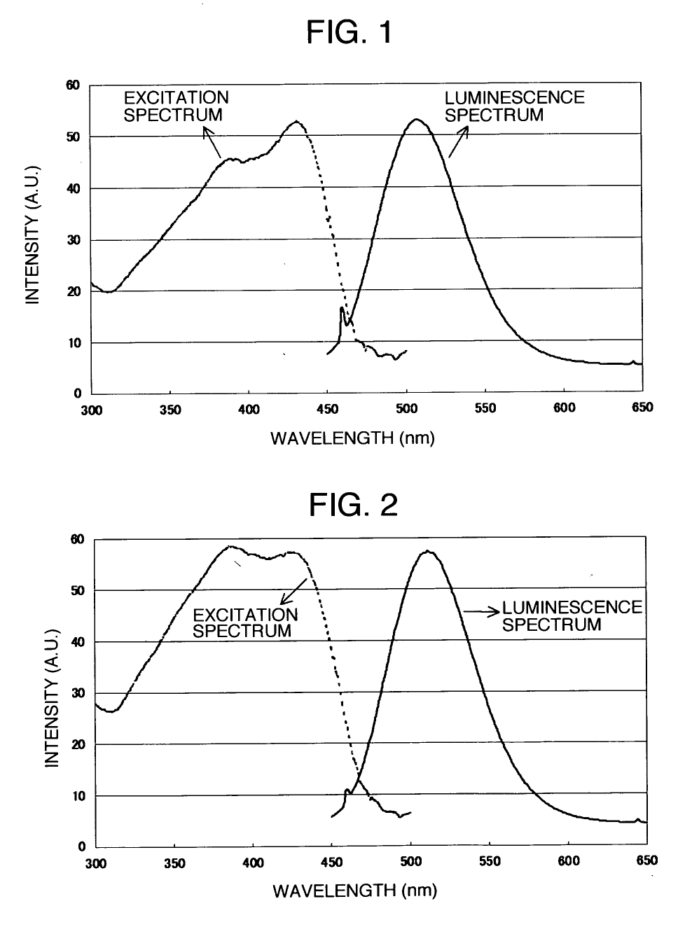

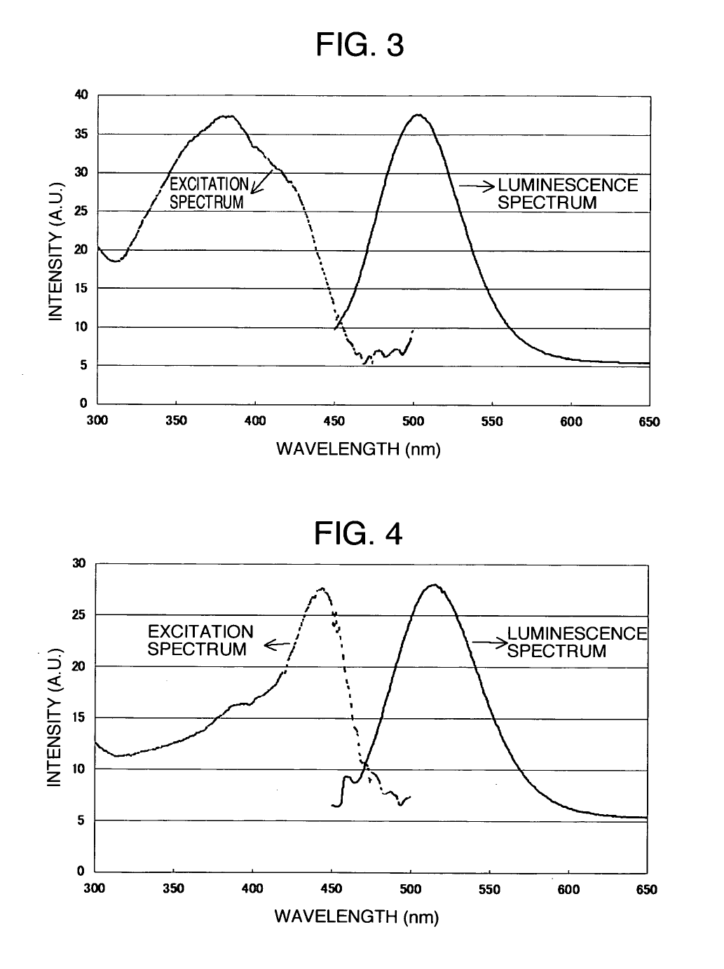

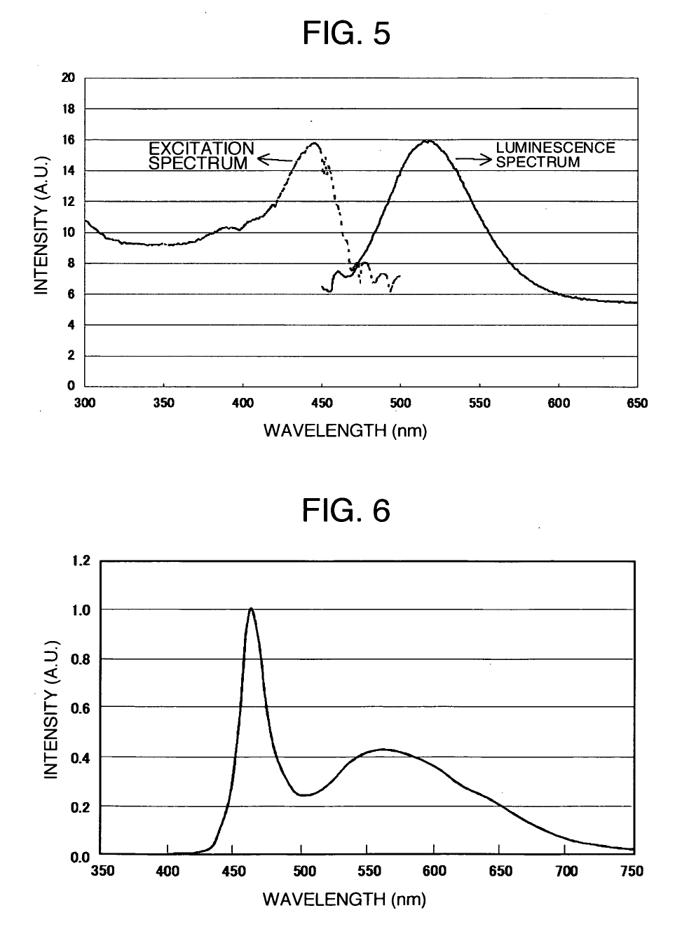

1. A phosphor comprising a compound represented by the formula aM¹O.bM²₂O₃.cM³O₂, wherein M¹ represents at least one element selected from the group consisting of Ba, Sr, Ca, Mg and Zn; M² represents at least one element selected from the group consisting of Al, Sc, Ga, Y, In, La, Gd and Lu; M³ represents at least one element selected from the group consisting of Si, Ti, Ge, Zr, Sn and Hf; a is a value of not less than 8 and not more than 10; b is a value of not less than 0.8 and not more than 1.2; and c is a value of not less than 5 and not more than 7, said compound comprising as an activator at least one element selected from the group consisting of rare earth elements, Mn, Bi and Zn.

2. A phosphor according to claim 1, wherein the activator is at least one element selected from the group consisting of Ce, Pr, Nd, Sm, Eu, Tb, Dy, Ho, Er, Tm, Yb, Mn, Bi and Zn.

3. A phosphor consisting essentially of a compound represented by the formula (M¹₁₋ₓReₓ)₉M²₂M³₆O₂₄, wherein M¹ represents at least one element selected from the group consisting of Ba, Sr, Ca, Mg and Zn; M² represents at least one element selected from the group consisting of Al, Sc, Ga, Y, In, La, Gd and Lu; M³ represents at least one element selected from the group consisting of Si, Ti, Ge, Zr, Sn and Hf; Re represents at least one element selected from the group consisting of Sm, Eu, Tm, Yb, Mn and Zn; and x is a value of more than 0 and less than 1.

4. A phosphor according to claim 3, wherein x is a value of not less than 0.01 and not more than 0.2.

5. A phosphor according to any one of claims 1-4, wherein M¹ represents at least one element selected from the group consisting of Ba, Sr and Ca.

6. A phosphor according to any one of claims 1-5, wherein M² represents Sc and/or Y.

7. A phosphor according to any one of claims 1-6, wherein M³ represents Si and/or Ge.

8. A light emitting device comprising the phosphor according to any one of claims 1-7.

9. A light emitting device comprising a light emitting element and a fluorescent material which emits light by excitation with at least a part of light emitted by the light emitting element, wherein the fluorescent material comprises the phosphor according to any one of claims 1-7.

10. A light emitting device according to claim 9, wherein the light emitted by the light emitting element shows maximum emission intensity at a wavelength (λmax) of not shorter than 350 nm and not longer than 480 nm in a wavelength-emission intensity curve of a wavelength range of not shorter than 300 nm and not longer than 780 nm.
